(19) United States
(12) Patent Application Publication
(10) Pub. No.: US 2006/0079225 A1
(43) Pub. Date: Apr. 13, 2006

(54) VLR roaming statistics for IPN (intelligent preferred network)

(76) Inventors: Shlomo Wolfman, Hod-HaSharon (IL); Shai Ophir, Moshav Ein-Vered (IL)

Correspondence Address: Martin Moynihan;PRTSI, Inc., P.O. Box 16446, Arlington, VA, 22215, US

(21) Appl. No.: 11/226,390

(22) Filed: Sep. 15, 2005

Related U.S. Application Data
(60) Provisional application No. 60/609,812, filed on Sep. 15, 2004.

(51) Int. Cl. H04Q 7/20

(52) U.S. Cl. 455/432.1

(57) ABSTRACT

A system and a method for determining redirection attempts in an IPN (Intelligent Preferred Network) while taking into account roaming VLR parameters. The system utilizes per-VLR roaming statistics to improve decisions regarding redirection attempts, thus further optimizing the IPN success ratio.

### RELATED APPLICATIONS

The present application claims priority from U.S. Provisional Patent Application No. 60/609,812, filed on Sep. 15, 2004. The contents of the above Applications are incorporated herein by reference.

### FIELD AND BACKGROUND OF THE INVENTION

The present invention relates to a system and a method for determining redirection attempts in IPN (Intelligent Preferred Network) implementations while taking into account roaming VLR parameters. The IPN service is based on network redirection attempts via SS7 MAP signaling or SIM OTA commands. Until now, the decision whether to attempt a network redirection process was based on several parameters such as the user profile and community, the elapsed time between connection attempts, and the specific visited network. However, none of these was defined at a per-VLR resolution.

There is thus a widely recognized need for a system and method that utilizes per-VLR roaming statistics to improve decisions regarding redirection attempts. Such a system and method described herein is devoid of the above limitations and significantly improves the IPN success ratio.

### SUMMARY OF THE INVENTION

The present invention is of a system and a method for determining network decisions in an Intelligent Preferred Network, having a probe at the home network for monitoring roamer registration attempts via Visitor Location Registers, and gathering statistics from said monitoring roamer registration attempts for determining redirection attempts.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a table showing VLR roaming statistics; and

FIG. 2 is an exemplary VLR topology visualization.

### DESCRIPTION OF THE PREFERRED EMBODIMENTS

The present invention is of a system and a method for determining redirection attempts in IPNs (Intelligent Preferred Network) while taking into account roaming VLR statistics.

Roaming statistics are received by the system through the monitoring of registration attempts (Update Location MAP messages and their responses) via an SS7 signaling probe. The probe is located at the HPMN, where the following information can be gathered:

a. Location Updates of roamers served by VLR Ax, (where A is the roaming network and x is the specific VLR identifier), attempting registration now at VLR By;

b. Location Updates of roamers served by VLR Ax, (where A is the roaming network and x is the specific VLR identifier), attempting registration now at VLR Az; and

c. Elapsed time since registration (to VLR Ax), until leaving to each one of the other networks/VLRs.

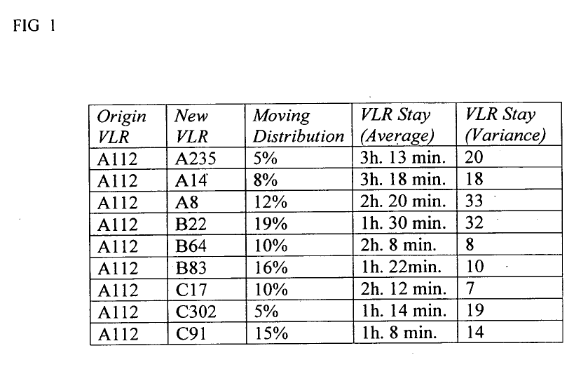

Based on the accumulated results, the statistics shown in the table of FIG. 1 can be created for each one of the VLRs (marked as Origin VLR). The VLR Stay columns in the table indicate the average stay of a roamer in that VLR and the variance. A lower variance implies a greater similarity among the VLR cells in keeping the roamer attached to the current network.

Several conclusions can be derived from the analysis of FIG. 1.

1. If the majority of roamers are leaving to another VLR of the same network, there is a high probability of having only one available network in most of the areas covered by that VLR, therefore causing temporary loss of connection after a potential redirection attempt;

2. If there is a low probability for moving into the preferred network from the current VLR, a redirection attempt is redundant and should be ‘reserved’ for a later use (assuming the guideline is to minimize the impact for the end user);

3. If the current Update Location is for a non preferred network, but for a new VLR with a relatively expected short stay, or with a relatively high potential for moving to a preferred network later on, a redirection attempt should not be ‘wasted’ at this point; and

4. For self-initiated redirection attempts (via SIM OTA Refresh command for example), as long as the actual stay (in a non-preferred network) exceeds the average stay, it is less worthwhile for a redirection attempt to be invoked, since the expected stay at the current VLR is shorter.

The above guidelines can be used in a decision flow chart with appropriate thresholds, where the outcome of the flow chart determines whether or not to perform a redirection attempt. This outcome can be combined with other system considerations, as already described in the Starhome patent pending preferred network application. Alternatively, this system could be implemented as an independent add-on, on top of the system described in the Starhome patent pending application.

According to a preferred embodiment of the present invention, a roamer served by VLR Ax (where x is a three digit VLR identifier) is attempting registration into A112. However, B is the preferred network and therefore a redirection attempt may be relevant. Upon analyzing the roaming statistics, it is determined that the average stay at A112 is short, the average stay variance is low, and most important, a high potential exists for moving from A112 to B (19%+10%+16%=45%). The conclusion therefore would be to not redirect.

At a later stage, a group-based analysis can be performed, taking into account parameters at the subscriber level. The groups may be handled separately by the system in an exemplary manner below.

1. Users with different preferred lists on their SIM cards;

2. Users with different handset families/types (i.e. GPRS handsets which attempt to register into GPRS networks);

3. “Manual selection” users (subscribers that frequently use the manual network selection option, see below); and

4. Any other parameter that may affect the automatic network selection behavior of the handset.

“Manual selection” users impose a problem for current IPN service networks, since rejecting a manual registration attempt will not cause the handset to change to a different roaming network. “Manual selection” users may be identified by comparing personal statistics with general statistics, on a per VLR case.

According to a preferred embodiment of the present invention, the statistics show that 45% of the roamers move from A112 to network B, and only 25% remain in network A. However a specific subscriber Px always stays at network A after visiting A112, and this is the case for other network A VLRs. That would indicate a manual selection process, unless the user has a preferred list on the SIM card where network A is the first choice (this information can be obtained from the operator).

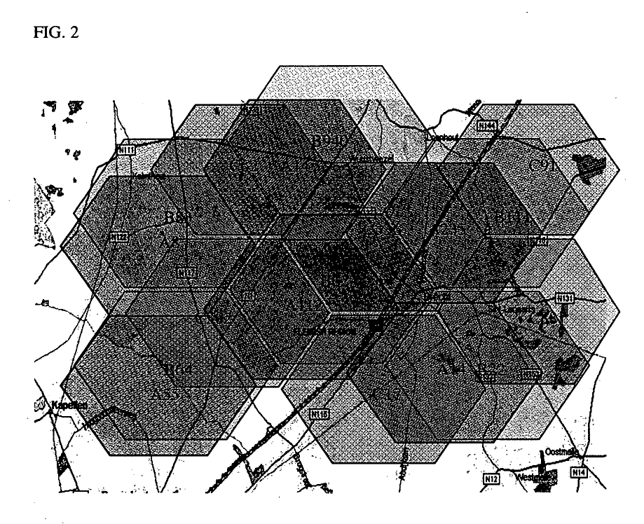

The above analysis leads to the creation of a global VLR topology as shown in FIG. 2. The global VLR topology is a worldwide mapping of all VLRs belonging to all cellular networks and the overlapping of VLRs in these networks. This topology is the graphical representation of the statistics data as exemplified in FIG. 1 and can be used for service provisioning and monitoring, which may be complex and tedious without such auxiliary means.

The topology system can also learn VPMN attributes dynamically, such as a network having GPRS or CAMEL support. These attributes may vary between VLRs belonging to the same network, as exists in China Mobile for example.

An additional parameter that the service monitoring system can learn is the QoS (Quality of Service) of the overall VPMN as well as specific VLRs in that VPMN. The QoS can be measured, for example, by the ratio of completed calls performed by roamers in each one of the roaming networks/VLRs during a period X. Alternatively the ratio of incompleted calls may be measured. The average ratio provides an indication of the QoS, and therefore a parameter in preferred network decision making (whether or not to attempt redirection).

A further example of a parameter relevant to the preferred network system is the actual volume of calls performed from a specific VPMN/VLR. These figures can be derived by either a real-time monitoring system, or alternatively using an off-line system that analyzes roaming data extracted from CDRs and other data sources.

If the IPN service is already running, the success/failure ratio can be measured per VLR, by accumulating successful and unsuccessful redirection attempts. This input is most valuable for making decisions regarding specific VLRs.

Similarly, different responses for rejecting Update Location messages can be observed and taken into consideration. For example, the total registration time may differ between VLRs, and certain VLRs can be marked as “don't reject”.

In an additional embodiment, a “temporary preferred VLR” is defined based on statistics extracted as described above. A “temporary preferred VLR” is a VLR which does not belong to a preferred network, but is treated as such, and Location Updates generated by this VLR are principally not rejected by the IPN system. This is due to the fact that this VLR has relatively “strong” RF coverage, and hence captures several roamers on behalf of other networks. Due to the relatively low coverage of the other networks, roamers may not have an alternative network or the roamers will shortly be captured again by this VLR. Therefore, registration attempts coming from this VLR are not rejected.

This is accomplished according to the following steps:

A VLR mapping of all VLRs in the relevant region is created. For each VLR, the map specifies the neighbouring VLRs on the same network and from different networks. That information is gathered according to subscriber transition between VLRs. For example, the system may find that Bx has the neighbouring VLRs By and Bz, and also overlapping with Ai, Aj, Ak and Cm, Cn.

Next, the system measures the distribution of subscribers among the various VLRs. The distribution shows, for each network, how the roamers registered within that network are divided among its VLRs. For example, among the 100% registered to A, the distribution may be Ai=5%, Aj=7%, Ak=12% and so on, and among the 100% registered to B the distribution may be Bx=13%, By =3%, etc. These measurements can be taken while the IPN is active, since if a VLR is “temporary preferred”, this attribute will be preserved under IPN as well.

Once the system has all the information regarding neighbouring networks and distribution, network decision making can occur.

Another preferred embodiment is the case wherein a specific VLR belongs to a non-preferred network, Bx. If Bx contains a number of registered roamers higher than the average of the other VLRs on network B, and if the delta exceeds a threshold TB, then Bx is a candidate for being “temporary preferred”.

The delta in theory is compared with the overlapping VLR of the preferred network A. But since there is no one-to-one overlap, the comparison is against the average of the neighbouring VLRs, in this case Ai, Aj, Ak. If this average is lower than the general average of VLRs of network A, and the delta is greater than a threshold TA, then VLR Bx is indeed a “temporary preferred” VLR over A. UL coming from this VLR should not be rejected then.

The IPN system may receive the roamer location at a greater resolution, such as the cell ID of the roaming network, or geographical location coordination via GPS or by other means. The roaming Cell ID can be received via CAMEL phase 3.

The IPN system bases decisions on location, allowing registration for a specific area, defined by a specific cell, to the exclusion of neighboring cells. Additionally, the IPN can be used by the local mobile operator as a tool for enable/disable services in specific areas. For example, a mobile handset can be allowed to perform calls only at the cell covering the home or work zone of the subscriber.

While the invention has been described with respect to a limited number of embodiments, it will be appreciated that many variations, modifications and other applications of the invention may be made.

What is claimed is:

1. An apparatus for obtaining data of cellular network selection decisions for a cellular roaming user connecting via a roaming cellular network to a home cellular network, comprising:
a probe at the home network for monitoring roamer registration attempts via Visitor Location Registers; and
a statistical gathering unit associated with said probe for gathering statistics from said monitoring roamer registration attempts for detection redirection attempts for redirecting said cellular user between potential roaming networks.

2. A method for determining network decisions when providing roaming registration to roaming cellular users attempting to select a roaming cellular network for connecting to a home cellular network, the method comprising:
probing in association with said home network to monitor roamer registration activity, and
gathering statistics from said roamer registration activity regarding said network decisions.

3. The method of claim 2, wherein the network decisions are registration attempts via given potential roaming networks.

4. The method of claim 3, wherein the statistics are statistics regarding success and failure of registrations attempts.
